(19) United States
(12) Patent Application Publication
(10) Pub. No.: US 2018/0015773 A1
(43) Pub. Date: Jan. 18, 2018

(54) EXPANDABLE FOLDER

(71) Applicant: Sungyoung Lee, Provo, UT (US)

(72) Inventor: Sungyoung Lee, Provo, UT (US)

(21) Appl. No.: 15/651,883

(22) Filed: Jul. 17, 2017

Related U.S. Application Data
(60) Provisional application No. 62/362,993, filed on Jul. 15, 2016.

(51) Int. Cl. B42F 7/06; B42F 15/02; B42F 15/00

(52) U.S. Cl. CPC B42F 7/06; B42F 15/0094; B42F 15/026

(57) ABSTRACT

An expandable folder includes a plurality of panels rotatably coupled to one another, and a number of sliding mechanisms slidingly coupled to a number of grooves defined in the panels. Engagement of the sliding mechanisms between groves defined in adjacent panels secures the adjacent panels in a planar orientation relative to one another.

### RELATED DOCUMENTS

The present application claims benefit under 35 U.S.C. §119(e) of U.S. Provisional Application No. 62/362,993, filed Jul. 15, 2016. These applications are herein incorporated by reference in their entireties.

### BACKGROUND

Musicians may use sheet music in performances and during practicing to play a musical piece. Sheet music for longer compositions are arranged on a number of separate pages or sheets. The musician may use a music stand to hold and prop up the individual sheets of music.

### BRIEF DESCRIPTION OF THE DRAWINGS

The accompanying drawings illustrate various examples of the principles described herein and are a part of the specification. The illustrated examples are given merely for illustration, and do not limit the scope of the claims.

FIG. 1 is a front plan view of a collapsible folder, according to one example of the principles described herein.

FIG. 2 is a front isometric view of the collapsible folder of FIG. 1, according to one example of the principles described herein.

FIG. 3 is a back plan view of the collapsible folder of FIG. 1, according to another example of the principles described herein.

FIG. 4 is a front isometric view of the collapsible folder of FIG. 1 in a collapsed, according to one example of the principles described herein.

FIG. 5 is an isometric view of the collapsible folder of FIG. 1 in a partially collapsed state, according to one example of the principles described herein.

FIG. 6 is an isometric view of the collapsible folder of FIG. 1 in a fully collapsed state, according to one example of the principles described herein.

Throughout the drawings, identical reference numbers designate similar, but not necessarily identical, elements.

### DETAILED DESCRIPTION

As mentioned above, a musician may use a music stand to hold and prop up the individual sheets of music. However, the individual sheets of music may become disordered and unregistered with regard to one another such that the musician may find it difficult to rearrange the individual sheets. Further, when arranged on, for example, a music stand, the individual sheets may fall away from a music stand due to even a simple breeze. Thus, it is difficult to maintain the arrangement of sheet music in order and in a manner viewable by the musician.

Thus, examples described herein provide a system for arranging sheet music. The system may include a plurality of panels coupled to one another, a number of sleeves coupled to each of the panels to hold media to the panels, and a number of sliding mechanisms slidingly coupled to a number of grooves defined in the panels. Engagement of the sliding mechanisms between groves defined in adjacent panels secures the adjacent panels in a planar orientation relative to one another. The adjacent panels may be coupled to one another via a living hinge. The sleeves may be transparent.

The grooves are defined in the panels using laser cutting methods. The sleeves are coupled the panels along three edges, and the fourth edge is uncoupled to the panels. The fourth edge includes a non-linear edge. The sleeves may be coupled to both sides of the panel where each panel includes a front sleeve and a back sleeve. The panels include a number of apertures defined in the panels.

Examples described herein provide an expandable folder. The expandable folder includes a plurality of panels rotatably coupled to one another, and a number of sliding mechanisms slidingly coupled to a number of grooves defined in the panels. Engagement of the sliding mechanisms between groves defined in adjacent panels secures the adjacent panels in a planar orientation relative to one another. The expandable folder may further include a number of sleeves, wherein at least one sleeve is coupled to each of the panels to hold media to the panels. The sleeves are coupled to a front and a back of each of the panels. The plurality of panels are rotatably coupled to one another via a number of living hinges. The sleeves may be transparent. The grooves may be defined in the panels using a laser cutting methods. The sleeves are coupled the panels along three edges, and the fourth edge is uncoupled to the panels. The fourth edge may include a non-linear edge. The sleeves may be coupled to both sides of the panels where each panel includes a front sleeve and a back sleeve. The panels may include a number of apertures defined in the panels. The expandable folder may include a utensil holder coupled to a surface of at least one panel. The expandable folder may also include a fastener to couple the panels to one another in a collapsed orientation.

As used in the present specification and in the appended claims, the term “a number of” or similar language is meant to be understood broadly as any positive number comprising 1 to infinity; zero not being a number, but the absence of a number.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described in connection with that example is included as described, but may not be included in other examples.

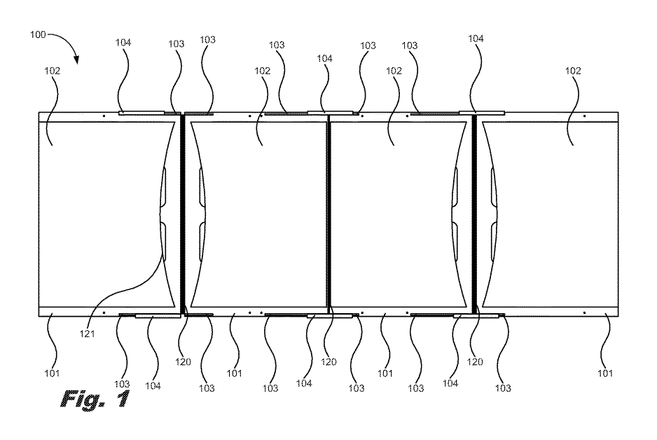

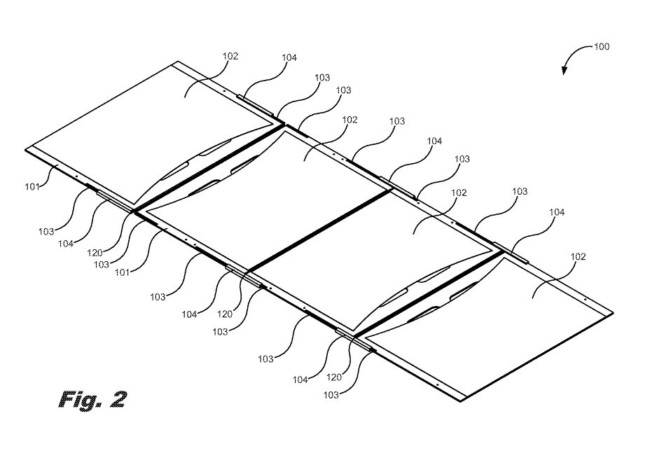

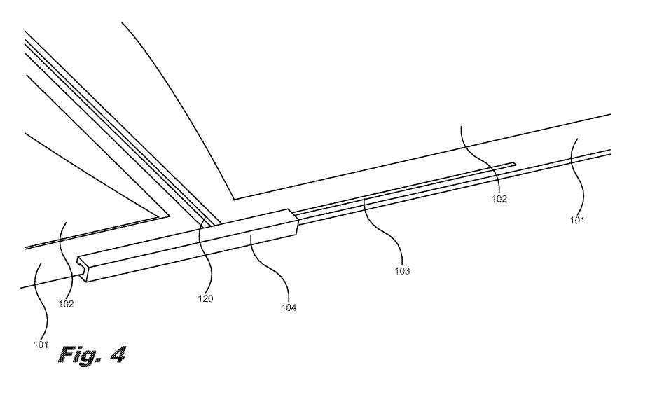

FIG. 1 is a front plan view of a collapsible folder (100) in an expanded orientation, according to one example of the principles described herein. Further, FIG. 2 is a front isometric view of the collapsible folder (100) of FIG. 1 in an expanded orientation, according to one example of the principles described herein. Still further, FIG. 4 is a front isometric view of the collapsible folder of FIG. 1 in a semi-collapsed orientation, according to one example of the principles described herein. The folder (100) is depicted in FIG. 1 as completely expanded. The folder (100) connects four panels (101) that can be used to hold sheet music via sleeves that hold media. Any number of panels (101) may be coupled together even though four panels (101) are depicted throughout the figures as being coupled together. In one example, the panels (101) may be coupled together using, for example, a living hinge (120). The living hinge may be any thin flexible hinge or flexure bearing made from the same material as the two adjacent panels (101) it connects. In one example, the living hinge (120) may be thinned or cut to allow the rigid adjacent panels (101) to bend along the line of the living hinge (120) and the result is a single piece of material forming the panels (101) and living hinge (120). The minimal friction and very little wear in the living hinge (120) makes them useful in the design of the folder (100), and provides for a low-cost folder that is easy to manufacture.

In one example, the media insertable into the folder (100) may be printed on any type of paper. A thin film covers each panel on the front and back as a sleeve (102), with three edges sealed and one unsealed to insert the media. The sleeves (102) serve as sheet coupling devices to couple the sheet music or other media to the folder (100). In this manner, the media may be removed from the sleeves (102), and replaced with other media such as in a situation where a user wishes to change out a number of pieces of sheet music. In one example, the unsealed edge (121) of the sleeve (102) may be cut to include a non-linear, angular or bowed edge to allow the media to be inserted without fraying the film after repeated multiple insertions of the media. The sleeves (102) may be made of a plastic.

Further, the sleeves (102) are made of a transparent or at least translucent material such that media inserted therein may be viewed by a user through the sleeves (102). Still further, the sleeves (102) may be included on both sides of the panels (101) of the folder (100). This allows a user to place media in the sleeves (102) on both sides of the folder (101), thus being able to include, in the example of FIGS. 1 through 6, up to eight sheets of media with a single flip of the folder (100) in a case where four panels (101) are coupled together.

Each panel (101) includes a number of grooves (103) and channel locks (104) slidingly coupled to the grooves (103) acting as sliding mechanisms that lock the panels (101) in an open, extended, flat orientation with respect to one another. The grooves (103) are located at the top and bottom portions of each of the panels (101). Further, the grooves (103) are defined in adjacent panels (101) at their adjacent corners such that the grooves (103) are extended from one panel (101) to an adjacent panel (101).

The grooves (103) may be defined within the panels (101) using any number of methods. In one example, the grooves (103) are formed using a laser cutting method. Laser cutting methods provide for a high-quality groove with very low tolerances. However, the grooves (103) may be defined in the panels (101) using, for example, molding methods, extrusion methods, drilling methods, cutting methods, other material formation methods, or combinations thereof.

The channel locks (104) may be, in one example, compression fitted onto the panels (101) and into the grooves (103) using an elastic property of the channel locks (104) to snap the channel locks (104) into place. However, in another example, the channel locks (104) may be formed from the same piece of material as the panels using, for example, three-dimensional (3D) printing techniques.

Each panel (101) includes grooves (103) defined in top and bottom corners of the panel (101), and an adjacent panel (101) includes grooves (103) defined in the top and bottom corners that abut the other panel (101). In this manner, each panel (101) has grooves (103) defined in its top and bottom corners where it abuts another panel (101) in order to allow the channel locks (104) to move from a first groove (103) defined in a first panel (101) to a second groove (103) defined in the second panel (101) as if the two adjacent grooves (103) are a single groove (103). As to an engaged and disengaged state of the channel locks (104) within the grooves (103), and engaged state may be defined as a state at which the channel locks (104) preclude the bending of two adjacent panels (101) relative to one another. A disengaged state may be defined as a state at which the channel locks (104) are moved to one panel (101) clear of the living hinge (120) and not touching the adjacent panel (101) or its grooves (103).

In one example, the grooves (103) that travel from one panel to another may be defined at a longer distance into one panel (101) than the other adjacent panel (101) in order to give the channel locks (104) space to fully disengage from a locking position where the channel locks (104) span between adjacent panels (101). The other panel (101) may have a shorter groove (103) defined therein such that this second groove (103) defined in the adjacent panel (101) stops the channel lock (104) within the adjacent grooves (103) at a point at which at least a portion of the channel lock (104) spans the two adjacent panels (101) and obstructs the living hinge (120). For example, as depicted in FIG. 1, the bottom left grooves (103) include a groove (103) defined in the left-most panel (101) in the bottom-left corner, and a groove (103) defined in the second to panel (103) in the bottom-right corner. The groove (103) defined in the bottom-left corner of the left-most panel (103) is longer than the width of the channel lock (104). This allows the channel lock (104) to be moved within the groove (103) defined in the bottom-left corner of the left-most panel (103) away from the living hinge (120), and allows the living hinge (120) to bend without being obstructed by any portion of the channel lock (104). In this state, the two left-most panels (101) of the collapsible folder (100) may bend with respect to one another to fold one panel (101) by 180 degrees such that the adjacent panels (101) are on top of one another.

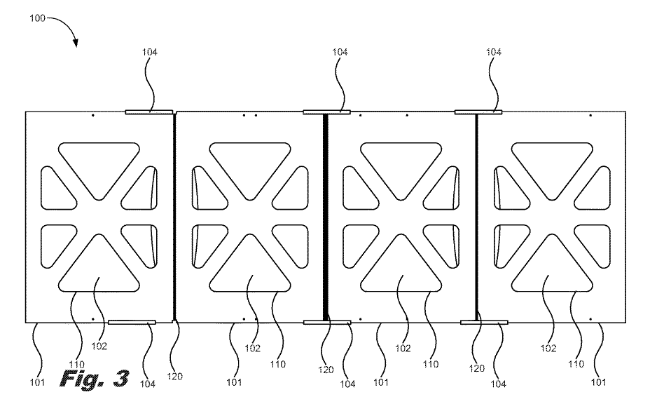

FIG. 3 is a back plan view of the collapsible folder (100) of FIG. 1 in an expanded orientation, according to another example of the principles described herein. As depicted in FIG. 3, the panels (101) may each include a number of apertures (110) defined therein. The apertures (110) serve to reduce the weight of the folder (100). In one example, a plurality of apertures (110) may be defined within the panels (101). Further, in one example, the apertures (110) may be defined within the panels (101) such that they reduce the weight of the folder (100) without compromising the strength or structural integrity of the panels (101) or the folder (100) as a whole.

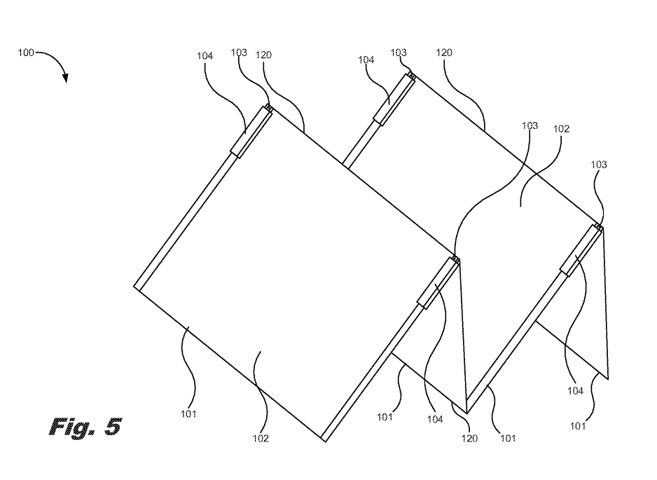

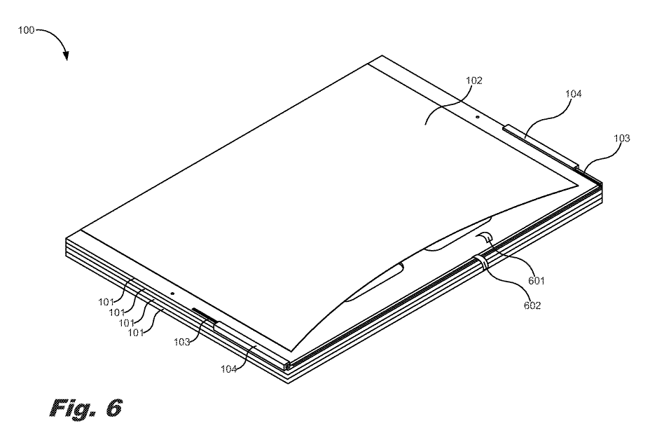

FIG. 5 is an isometric view of the collapsible folder (100) of FIG. 1 in a partially collapsed state, according to one example of the principles described herein. Further, FIG. 6 is an isometric view of the collapsible folder of FIG. 1 in a fully collapsed state, according to one example of the principles described herein. In order to collapse the folder (101) from the state depicted in FIGS. 1 through 4 and into the partially collapsed state of FIG. 5 and the fully collapsed state depicted in FIG. 6, the channel locks (104) on each of the panels (101) are disengaged. In this disengaged state, the panels (101) are able to fold onto one another. Even though the panels (101) are depicted in FIG. 5 at angles, the panels (101) may be folded 180 degrees such that the panels (101) may be folded onto one another as depicted in FIG. 6.

In one example, as depicted in FIG. 6, the folder (100) may also include a utensil holder (601) coupled to a surface of at least one panel (101). The utensil holder (601) may be used to store, for example, a writing utensil for the user to use as they mark the pages of the media. Further, in one example, the utensil may be an erasable marker that may be used in conjunction with the transparent sleeves (102) to mark the sleeves (102) as opposed to the media directly. In another example, the user may remove the media from the sleeve (102) via the open side of the sleeve (102), thus maintaining the physical integrity of the folder (100).

In one example, the folder (100) may include a fastener (602) to couple the panels (101) to one another in a collapsed orientation. As depicted in FIG. 6, the fastener (602) may span the width of the stack of panels (101) so as to secure the panels (101) in the collapsed, stacked state. The fastener may be any device used to couple the panels (101) together, and may include, for example, fabric hook and loop fasteners such as VELCRO manufacture and distributed by Velcro Companies, tapes, straps, clasps, other fasteners, or combinations thereof. In another example, the fastener (602) may include a number of button snaps located on and between each panel (10a). In this example, the button snaps may have mating and complimentary components located on neighboring panels (101) such that when the panels (101) are brought into a collapsed state as depicted in FIG. 6, the button snaps engage and couple the panels (101) in the collapsed state. In still another example, the fastener (602) may include a number of complimentary magnets located on and between each panel (10a). In this example, the magnets may cause each panel (101) to be coupled to one another when the panels (101) are brought into a collapsed state as depicted in FIG. 6 due to the magnetic attraction between the complimentary magnets.

The specification and figures describe an expandable folder. The expandable folder includes a plurality of panels rotatably coupled to one another, and a number of sliding mechanisms slidingly coupled to a number of grooves defined in the panels. Engagement of the sliding mechanisms between groves defined in adjacent panels secures the adjacent panels in a planar orientation relative to one another.

The preceding description has been presented to illustrate and describe examples of the principles described. This description is not intended to be exhaustive or to limit these principles to any precise form disclosed. Many modifications and variations are possible in light of the above teaching.

What is claimed is:

1. A system for arranging sheet music comprising:
a plurality of panels coupled to one another;
a number of sleeves coupled to each of the panels to hold media to the panels; and
a number of sliding mechanisms slidingly coupled to a number of grooves defined in the panels,
wherein engagement of the sliding mechanisms between groves defined in adjacent panels secures the adjacent panels in a planar orientation relative to one another.

2. The system of claim 1, wherein the adjacent panels are coupled to one another via a living hinge.

3. The system of claim 1, wherein the sleeves are transparent.

4. The system of claim 1, wherein the grooves are defined in the panels using laser cutting methods.

5. The system of claim 1, wherein:
the sleeves are coupled the panels along three edges, and
the fourth edge is uncoupled to the panels.

6. The system of claim 1, wherein the fourth edge comprises a non-linear edge.

7. The system of claim 1, wherein the sleeves are coupled to both sides of the panels, each panel comprising a front sleeve and a back sleeve.

8. The system of claim 1, wherein the panels comprise a number of apertures defined in the panels.

9. An expandable folder comprising:
a plurality of panels rotatably coupled to one another; and
a number of sliding mechanisms slidingly coupled to a number of grooves defined in the panels,
wherein engagement of the sliding mechanisms between groves defined in adjacent panels secures the adjacent panels in a planar orientation relative to one another.

10. The expandable folder of claim 9, further comprising a number of sleeves, wherein at least one sleeve is coupled to each of the panels to hold media to the panels.

11. The expandable folder of claim 10, wherein the sleeves are coupled to a front and a back of each of the panels.

12. The expandable folder of claim 9, wherein the plurality of panels are rotatably coupled to one another via a number of living hinges.

13. The expandable folder of claim 10, wherein the sleeves are transparent.

14. The expandable folder of claim 9, wherein the grooves are defined in the panels using a laser cutting methods.

15. The expandable folder of claim 10, wherein:
the sleeves are coupled to the panels along three edges, and
the fourth edge is uncoupled to the panels.

16. The expandable folder of claim 15, wherein the fourth edge comprises a non-linear edge.

17. The expandable folder of claim 10, wherein the sleeves are coupled to both sides of the panels, each panel comprising a front sleeve and a back sleeve.

18. The expandable folder of claim 9, wherein the panels comprise a number of apertures defined in the panels.

19. The expandable folder of claim 9, comprising a utensil holder coupled to a surface of at least one panel.

20. The expandable folder of claim 9, comprising a fastener to couple the panels to one another in a collapsed orientation.
